(19) United States
(12) Patent Application Publication
(10) Pub. No.: US 2013/0069269 A1
(43) Pub. Date: Mar. 21, 2013

(54) SYSTEM AND METHOD FOR MANUFACTURING BONDED MAGNET USING RARE EARTH POWDER

(71) Applicant: Jae Ryung Lee, Hwaseong (KR)

(72) Inventor: Jae Ryung Lee, Hwaseong (KR)

(73) Assignee: HYUNDAI MOTOR COMPANY, Seoul (KR)

(21) Appl. No.: 13/323,735

(22) Filed: Dec. 12, 2011

(30) Foreign Application Priority Data
Sep. 20, 2011 (KR) 10-2011-0094479

(51) Int. Cl. H01F 41/02

(52) U.S. Cl. 264/101; 264/122

(57) ABSTRACT

Disclosed is a system and method for manufacturing a bonded magnet using a rare earth powder. In particular, a residual rare earth magnet scrap is pulverized to manufacture a regenerated powder using an HDDR process (hydrogenation, disproportionation, desorption, and recombination). Then a raw material of a neodymium magnet (Nd—Fe—B) is melted down to manufacture an alloy powder using a quenching process. Subsequently the regenerated powder, the alloy powder, and a binder are mixed together to manufacture a resulting mixture which is then mixed with a thermoplastic resin or a thermosetting resin to manufacture the bonded magnet using a compression process or an injection process.

### CROSS-REFERENCE TO RELATED APPLICATION

This application claims under 35 U.S.C. §119(a) the benefit of Korean Patent Application No. 10-2011-0094479 filed on Sep. 20, 2011 the entire contents of which are incorporated herein by reference.

### BACKGROUND

(a) Technical Field

The present disclosure relates to a system and method for manufacturing a bonded magnet using rare earth powder according to an HDDR process using commercial neodymium magnet powder (Nd—Fe—B) and scrap or a waste rare earth magnet.

(b) Background Art

A rare earth bonded permanent magnet having magnetism that is 3 to 5 times higher than that of a known ferrite magnet is capable of effectively reducing the size and weight of a motor in electric or hybrid cars which employ electric motors in order to provide a driving force. However, costly rare earth raw material is used in these motors and thus increases the cost of the motor. This is due to the fact that the amount of rare earth element reserves is smaller than that of other metals and thus restricts the number of resources available to the automotive manufactures. Even furthermore, the rare earth element reserves are concentrated underground in specific areas that are often difficult to reach and thus are costly to mine. Accordingly, there is a difficulty in providing a sufficient supply and demand due to the above factors.

Recently, however, rare earth sintered magnet scrap has been used as a starting raw material to significantly reduce a manufacturing cost during manufacturing of R—Fe—B-based powder for a bonded magnet, and magnetic properties of rare earth powder has been improved using an improved HDDR (hydrogenation-disproportionation-desorption-recombination) process.

Furthermore, a method for performing the improved HDDR process, that is, the hydrogenation, the disproportionation, and the desorption, using low-priced starting raw materials such as process scrap generated during manufacturing of the rare earth sintered magnet, defective products, or rare earth sintered magnet products recovered from discarded products, additionally performing the disproportionation and the desorption, and performing the recombination is used to provide a method for manufacturing powder for a rare earth bonded magnet. This process forms a stable R—Fe—B-based powder having excellent magnetic performance and a uniform quality.

However, even though isotropic rare earth powder and anisotropic rare earth powder can be manufactured efficiently, the isotropic rare earth powder has high coercivity and low residual magnetic flux density. Further, the anisotropic rare earth powder has high residual magnetic flux density and low coercivity.

Both the residual magnetic flux density and the coercivity need to be high to apply the powder to a magnet in vehicle motors, but it is not easy to satisfy both of these requirements thus, typically causes difficulties in application thereof.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art, and to provide a system and method for manufacturing a low-priced rare earth bonded magnet having high performance using rare earth powder according to an HDDR process using commercial neodymium magnet (Nd—Fe—B) powder and scrap or a waste rare earth magnet.

In one aspect, the present invention provides a system and method for manufacturing a bonded magnet using a rare earth powder, including a regeneration step for pulverizing a residual rare earth magnet scrap to manufacture a regenerated powder using an HDDR process (hydrogenation, disproportionation, desorption, and recombination); an alloying step for melting a raw material of a neodymium magnet (Nd—Fe—B) to manufacture an alloy powder using a quenching process; a mixing step for mixing the regenerated powder, the alloy powder, and a binder to manufacture a mixture; and a manufacturing step for mixing the mixture with a thermoplastic resin or a thermosetting resin to manufacture the bonded magnet using a compression process or an injection process. Preferably, the regeneration step may include pulverizing the residual rare earth magnet scrap to have a size of about 0.1 to 1000 μm.

In some embodiments, the regeneration step may include heating the powder pulverized during the hydrogenation of the HDDR process in a vacuum of about 2×10⁻² torr or less while hydrogen is filled to about 0.3 to 2.0 atm. Additionally, the regeneration step may include maintaining the disproportionation of the HDDR process at a temperature of 750° C. or more for 10 min to 1 hour.

Furthermore, the disproportionation of the regeneration step may be performed while hydrogen is maintained at 1.0 to 2.0 atm to manufacture an isotropic regenerated powder, and the regeneration step may include discharging hydrogen filled during the desorption of the HDDR process until a pressure is 200 torr and maintaining the pressure for 5 to 20 min.

In further embodiments, the regeneration step may include discharging hydrogen filled during the recombination of the HDDR process until a pressure is 5 to 10 torr. Also, the alloying step may include melting and cooling the raw material of the neodymium magnet (Nd—Fe—B) to form a platy powder having a thickness of 5 to 50 μm and pulverizing the platy powder to have a diameter of 50 to 250 μm. The mixing step may include providing the binder in an amount of 1 to 10 wt %.

In yet another further embodiment, the manufacturing step may include mixing the mixture and the thermosetting resin, performing drying in a vacuum oven at about 60° C. or less for about 30 min to 2 hours, providing a lubricant in an amount of about 0.01 to 2% based on an amount of the powder, performing pressing using a mold, and performing heat treatment at about 100° C. or more for about 30 min to 2 hours.

In still yet another further embodiment, the alloying step may further include processing the manufactured alloy powder using the HDDR process to form an anisotropic alloy powder.

### DETAILED DESCRIPTION

Hereinafter reference will now be made in detail to a method for manufacturing a bonded magnet using rare earth powder according to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

For example, costly MQ powder (manufactured by Magquench, Co., Ltd. in the US) having excellent magnetic properties increases the cost of a motor, and isotropic powder reduces performance of the motor due to its low magnetic properties even though low-priced isotropic powder manufactured using scrap or rare earth magnet waste according to an HDDR (hydrogenation-disproportionation-desorption-recombination) process can reduce a cost of the motor. Therefore, the present invention aims to manufacture a low-priced rare earth bonded magnet having high performance using a process for mixing, e.g., MQ powder and isotropic powder manufactured using scrap or rare earth magnet waste according to an HDDR (hydrogenation-disproportionation-desorption-recombination) process and a process for manufacturing a magnet using the same.

The method for manufacturing a bonded magnet using a rare earth powder according to the present invention includes a regeneration step for pulverizing a residual rare earth magnet scrap to manufacture a regenerated powder using an HDDR process (hydrogenation, disproportionation, desorption, and recombination); an alloying step for melting a raw material of a neodymium magnet (Nd—Fe—B) to manufacture an alloy powder using a quenching process; a mixing step for mixing the regenerated powder, the alloy powder, and a binder to manufacture a mixture; and a manufacturing step for mixing the mixture with a thermoplastic resin or a thermosetting resin to manufacture the bonded magnet using a compression process or an injection process.

Particularly, in the regeneration step, the residual rare earth magnet scrap may be pulverized to have a size of about 0.1 to 1000 μm, and in the regeneration step, the powder pulverized during the hydrogenation of the HDDR process may be heated in a vacuum of about 2×10⁻² torr or less while hydrogen is filled to about 0.3 to 2.0 atm.

Further, it is preferable that in the regeneration step, the disproportionation of the HDDR process is maintained at a temperature of 750° C. or more for 10 min to 1 hour, and that the disproportionation of the regeneration step is performed while hydrogen is maintained at 1.0 to 2.0 atm to manufacture an isotropic regenerated powder. In addition, in the regeneration step, hydrogen filled during the desorption of the HDDR process is discharged until a pressure is 200 torr and the pressure is maintained for 5 to 20 min, and hydrogen filled during the recombination of the HDDR process is discharged until a pressure is 5 to 10 torr.

The alloying step includes melting and cooling the raw material of the neodymium magnet (Nd—Fe—B) to form a platy powder having a thickness of about 5 to 50 μm and pulverizing the platy powder to have a diameter of about 50 to 250 μm. The mixing step includes providing the binder in an amount of about 1 to 10 wt %, and the manufacturing step includes mixing the mixture and the thermosetting resin, drying the mixture in a vacuum oven at 60° C. or less for 30 min to 2 hours, providing a lubricant in an amount of about 0.01 to 2% based on an amount of the powder, pressing the powder using a mold, and performing heat treatment at 100° C. or more for 30 min to 2 hours.

Furthermore, the alloying step may further include processing the manufactured alloy powder using the HDDR process to form an anisotropic alloy powder.

A description is given of specific examples and effects thereof below.

### EXAMPLES

The following examples illustrate the invention and are not intended to limit the same.

### Example 1

Example 1 includes a regeneration step for pulverizing R—Fe—B-based rare earth magnetic powder manufactured using a scrap rare earth magnet according to an HDDR process to form powder, an alloying step for melting a rare earth raw material to manufacture powder using a quenching process, a mixing step for mixing the powders at a predetermined ratio, and a manufacturing step for mixing the powder with a thermosetting or thermoplastic synthetic resin to form a mixture and shaping the mixture to form a compressed or injection bonded magnet.

In the regeneration step, the R—Fe—B-based rare earth magnetic powder is pulverized using the scrap rare earth magnet by a pulverizer to manufacture the rare earth powder according to the HDDR process. The raw material of the scrap or the waste magnet includes 20 to 35 wt % of rare earth (Nd, Pr, Dy, Tb, Sm, and Y), 1 to 3 wt % of transition metal (Co, Al, and Cu), 0.5 to 1.5 wt % of B, and the balance is iron (Fe).

Process scrap generated during the manufacturing process of the rare earth sintered magnet, defective products, or rare earth sintered magnet products recovered from discarded products as the starting material are coarsely pulverized to have a size of 0.1 to 1000 μm. When the sintered magnet scrap is finely pulverized to have a size of less than 0.1 μm, the surface area of the powder is increased to cause excessive exposure to oxygen during the HDDR process, and when the size is more than 1000 μm, cracking occurs in the powder due to expansion and shrinkage of a volume caused by a phase transform during the HDDR process.

(Hydrogenation) The pulverized powder was disposed in the tube, the initial vacuum was maintained at 2×10⁻⁵ torr or less, hydrogen gas was supplied to 1.0 atm, and the temperature was increased from normal temperature to 300° C. to perform the hydrogenation. The scrap used as the starting material included R2Fe14B and R-rich phases. However, the scrap is bonded to hydrogen during the hydrogenation to form the hydrogenated compound of R2Fe14BHX+RHX.

Preferably, hydrogen is filled at 0.3 to 2.0 atm while the vacuum state is maintained at 2×10-2 torr or less. When the hydrogen pressure is less than 0.3 atm, the HDDR process reaction insufficiently occurs, and when the pressure is more than 2.0 atm, an additional device treating hydrogen gas at a high pressure is required, thus increasing a process cost. Particularly, the isotropic powder having the high coercivity may be manufactured at 1 atm, and the anisotropic powder having the high residual magnetic flux density may be manufactured at 0.3 atm.

(Disproportionation) The temperature was maintained for 15 min to 1 hour after the temperature of the tube furnace was increased to 810° C. in a hydrogen atmosphere to perform the disproportionation, thus forming α-Fe+Fe2B+NdHX. Since the disproportionation is completely finished within 1 hour, a cost is increased in the case of 1 hour or more. However, in the case of 10 min or less, the disproportionation is incompletely performed to reduce the magnetic properties.

(Desorption) After the disproportionation, hydrogen was discharged from the tube furnace until the hydrogen pressure was 200 torr, and the pressure was maintained for 5 to 20 min.

(Recombination) The recombination was performed while the vacuum discharging was performed until the hydrogen pressure in the tube furnace reached 10⁻⁵ torr to manufacture the R—Fe—B-based rare earth magnetic powder.

Next, the amide-based lubricant solution was mixed to improve corrosion resistance of the powder, the solvent was removed from the solution, and mixing was performed using the mixer for 30 min to 2 hours to manufacture powder of which the surface was coated with the amide-based lubricant to improve the corrosion resistance of the powder. The rare earth raw material was then melted to manufacture the powder using the quenching process. Commercial “MQP B2+ powder” (Magquench, Co., Ltd.) was used as this powder. The rare earth raw material including 25 to 35 wt % of the rare earth (Nd), 0.8 to 1.2 wt % of B, and the balance of Fe was sufficiently melted using a high-frequency melting furnace at 1500° C. for 5 hours, and the molten material was added to the surface of the Cu wheel rotating at 50 m/sec in the melt spinning device at normal temperature using the quenching process, and quenched to manufacture platy rare earth alloy powder having a thickness of 5 to 50 μm. The powder having the diameter of 50 to 250 μm was manufactured using the pulverizer.

Further, the powders were mixed at a predetermined ratio. The HDDR isotropic coarse powder (100 to 225 μm) including the scrap and the commercial MQP-B2+powder (50 to 200 μm) including the binder (epoxy) and the lubricant were mixed so that the amount of the HDDR powder was 100-X and the amount of the MQP-B2+powder was X (X=5 to 95 wt %) using the mixer for 30 min to 2 hours. The powder and the thermosetting or thermoplastic synthetic resin were then mixed to form the mixture, and the mixture is shaped to form a compressed or injection bonded magnet.

The selection of the synthetic resin is determined by the method for manufacturing the bonded magnet, and the compressed bonded magnet preferably includes a thermosetting resin such as an epoxy-based resin, a phenol-based resin, and a urea-based resin, and the injection bonded magnet preferably includes a thermoplastic resin such as a nylon resin.

A compression type manufacturing method is preferably used to manufacture a high density magnet, and it is preferable that the weight of the synthetic resin added to manufacture the compressed bonded magnet is about 1 to 5 wt % based on the total weight of the bonded magnet. After the epoxy resin was mixed in an amount of 1 to 5 wt %, a curing agent, a curing promoter, and acetone were mixed to manufacture a binder. When the amount is less than 1 wt %, the powder is not completely coated with the resin to reduce bonding force, and when the amount is more than 10 wt %, shaping density of the magnet is reduced.

The powder was added to the mixer and mixed. Further, drying was performed in the vacuum oven at 60° C. or less for 30 min to 2 hours. When the drying is performed for less than 30 min, the solvent is incompletely removed, and when the drying is performed for 2 hours or more, oxidation occurs on the surface of the powder to reduce the magnetic properties. After disintegration, the internal lubricant was added in an amount of 0.01 to 0.2% based on the amount of the powder. When the amount is 0.01% or less, fluidity of the powder is reduced and abrasion of the powder occurs during shaping in the mold. When the amount is 2% or more, the external side of the mold needs to be deoiled after the shaping, and oil remains around the powder to reduce the shaping density, thus reducing the magnetic properties.

The manufactured compound was subjected to a process for forming a compressed shaped body having a diameter (mm) X, a height (mm) and density of about 5.5 g/cc or more using a press at 14 torr/cm² and then heat treated at 150° C. for 30 min to 2 hours. A process for forming a magnet using epoxy surface treatment and magnetization was then performed. With respect to evaluation of the magnetic properties, the magnet having the Bhmax of 8 MGOe or more, the iHc of 10 kOe or more, and Br of 7 kG or more may be called a high-performance magnet.

After the rare earth magnetic powder manufactured during the above process was not arranged or arranged in a 1 T magnetic field, the magnetic properties were measured using a vibrating sample magnetometer, and magnetic property values of the bonded magnet composite including the HDDR powder (100-X) and the MQP-B2+(X) (X=5 to 95wt %) are as follows.

TABLE 1

| | Residual magnetic flux | Coercivity |
|---|---|---|
| | density Br (kG) | iHc (kOe) |
| Comparative example X = 0 | 7.45 | 13.2 |
| X = 10 | 7.63 | 13.1 |
| X = 20 | 7.85 | 12.6 |
| X = 30 | 7.96 | 12.3 |
| X = 50 | 8.3 | 11.6 |
| Comparative example X = 100 | 9.0 | 10.2 |

### Example 2

After the R—Fe—B-based rare earth magnetic powder manufactured in example 1 of the present invention and including the waste magnet and the scrap according to the HDDR process was not arranged or arranged in a 1 T magnetic field, the magnetic properties were measured using a vibrating sample magnetometer, and the results are described in the following Table 2. When the hydrogen pressure was 0.3 atm during the disproportionation, the magnetic properties depending on the time of the disproportionation were measured as described in Table 2. In connection with this, the anisotropic powder properties were obtained.

Furthermore, when the disproportionation is performed at a hydrogen pressure of 1 atm, the isotropic powder is manufactured, and the measured magnetic properties are described in Table 3. Therefore, it could be seen that the case where the hydrogen pressure was 1 atm during the disproportionation of the present invention was better than the case where the hydrogen pressure was 0.3 atm.

TABLE 2

| | Disproportionation | | | |
|---|---|---|---|---|
| | process condition | | Residual | |
| | Hydrogen | Time | magnetic flux | Coercivity |
| Division | pressure (atm) | (min) | density Br (kG) | iHc (kOe) |
| Example 1 | 0.3 | 30 | 11.65 | 6.30 |
| Example 2 | 0.3 | 60 | 11.40 | 7.52 |
| Example 3 | 0.3 | 120 | 11.52 | 8.05 |

TABLE 3

| | Disproportionation | | | |
|---|---|---|---|---|
| | process condition | | Residual | |
| | Hydrogen | Time | magnetic flux | Coercivity |
| Division | pressure (atm) | (min) | density Br (kG) | iHc (kOe) |
| Example 4 | 1.0 | 30 | 7.45 | 13.02 |
| Example 5 | 1.0 | 60 | 7.39 | 12.95 |
| Example 6 | 1.0 | 120 | 7.35 | 12.85 |

### Example 3

The test condition was the same as that of example 1 of the present invention, and the same manufacturing process as example 1 was performed, except that the rare earth isotropic powder including the scrap were formed of the fine powder having the particle diameter of 0.1 to 50 μm and the coarse powder having the particle diameter of 50 to 500 μm. After the powder was not arranged or arranged in a 1 T magnetic field, the magnetic properties were measured using a vibrating sample magnetometer, and the results are described in the following Table 4. In Table 4, the magnet includes only the rare earth isotropic powder including the scrap.

In Table 5, the rare earth powder having the scrap including the fine powder and the coarse powder mixed at a ratio of 5:5, and the commercial MQP-B2+ powder are mixed at a ratio of 5:5, 6:4, 7:3, 8:2, 9:1, and 10:0. After the powder was not arranged or arranged in a 1 T magnetic field, the magnetic properties were measured using a vibrating sample magnetometer, and the results are described in the following Table 5.

TABLE 4

| Fine powder:coarse powder | Residual | |
|---|---|---|
| in rare earth isotropic | magnetic flux | Coercivity |
| powder using scrap | density Br (kG) | iHc (kOe) |
| 5:5 | 7.45 | 13.2 |
| 6:4 | 7.43 | 13.1 |
| 7:3 | 7.40 | 13.0 |
| 8:2 | 7.48 | 13.6 |
| 9:1 | 7.45 | 12.9 |

TABLE 5

| Ratio of rare earth isotropic | | |
|---|---|---|
| powder using scrap (fine | Residual | |
| powder:coarse powder = (5:5)) | magnetic flux | Coercivity |
| to MQ powder | density Br (kG) | iHc (kOe) |
| 5:5 | 8.4 | 11.9 |
| 6:4 | 8.3 | 12.4 |
| 7:3 | 7.9 | 12.6 |
| 8:2 | 7.72 | 12.8 |
| 9:1 | 7.55 | 13.6 |

### Example 4

Example 4 includes a regeneration step for pulverizing R—Fe—B-based rare earth magnetic powder manufactured using a scrap rare earth magnet according to an HDDR process to form powder, an alloying and processing step for high-frequency melting and molding a rare earth raw material (Nd: 25 to 35 wt %, B: 1 wt %, Co: 1 to 2 wt %, Al: 0.5 wt %, and Fe: balance) to manufacture an alloy using a quenching process, and manufacturing anisotropic rare earth bonded powder using the HDDR process, a mixing step for mixing the powders at a predetermined ratio, and a manufacturing step for kneading the powder and a thermosetting or thermoplastic synthetic resin to form a mixture and shaping the mixture to form a compressed or injection bonded magnet. Particularly, the processing step of the method for manufacturing the bonded magnet includes manufacturing rare earth anisotropic powder using commercial powder according to the HDDR process.

In Example 4, costly rare earth anisotropic powder (e.g., “JHMF 25” manufactured by AICHI Steel, Co., Ltd. in Japan) having high magnetic properties and known rare earth powder including scrap are mixed to improve the magnetic properties and obtain low-priced rare earth powder. The magnetic property results thereof are as follows. After the rare earth magnetic powder was not arranged or arranged in a 1 T magnetic field, and the magnetic properties were measured using a vibrating sample magnetometer, and magnetic property values of the bonded magnet composite including the scrap HDDR powder (100-X) and the anisotropic powder (X) (X=5 to 95 wt %) are as follows.

TABLE 6

| | Residual magnetic flux | Coercivity |
|---|---|---|
| | density Br (kG) | iHc (kOe) |
| Comparative example X = 0 | 7.45 | 13.2 |
| X = 10 | 7.92 | 13.0 |
| X = 20 | 8.35 | 12.6 |
| X = 30 | 9.02 | 11.9 |
| X = 50 | 9.5 | 11.6 |
| Comparative example X = 100 | 12.5 | 10.2 |

According to the method for manufacturing the bonded magnet using rare earth powder, it is possible to provide a low-priced rare earth bonded magnet having high performance using rare earth powder according to an HDDR process using commercial neodymium magnet powder (Nd—Fe—B) and scrap or rare earth magnet waste. Furthermore, low-priced waste scrap is used to reduce a cost, provide an environmentally-friendly process, and contribute to stabilization of supply and demand of rare earth resources, and high quality rare earth powder is mixed with the waste scrap to avoid some of the disadvantages associated with the prior art, thus applying the waste scrap to a magnet for motors and contributing to cost, size, and weight reduction of the magnet.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a bonded magnet using a rare earth powder, comprising:
pulverizing a residual rare earth magnet scrap to manufacture a regenerated powder using an HDDR process (hydrogenation, disproportionation, desorption, and recombination);
melting a raw material of a neodymium magnet (Nd—Fe—B) to manufacture an alloy powder using a quenching process;
mixing, by a mixer, the regenerated powder, the alloy powder, and a binder to manufacture a mixture; and
mixing the mixture with a thermoplastic resin or a thermosetting resin to manufacture the bonded magnet using a compression process or an injection process.

2. The method of claim 1, wherein pulverizing further comprising pulverizing the residual rare earth magnet scrap to have a size of 0.1 to 1000 μm.

3. The method of claim 1, further comprising heating the powder pulverized during the hydrogenation of the HDDR process in a vacuum of 2×10⁻² torr or less while hydrogen is filled to 0.3 to 2.0 atm.

4. The method of claim 1, further comprising maintaining the disproportionation of the HDDR process at a temperature of 750° C. or more for 10 min to 1 hour.

5. The method of claim 4, wherein the disproportionation is performed while hydrogen is maintained at 1.0 to 2.0 atm to manufacture an isotropic regenerated powder.

6. The method of claim 1, further comprising discharging hydrogen filled during the desorption of the HDDR process until a pressure is 200 torr and maintaining the pressure for 5 to 20 min.

7. The method of claim 1, further comprises discharging hydrogen filled during the recombination of the HDDR process until a pressure is 5 to 10 torr.

8. The method of claim 1, further comprising melting and cooling the raw material of the neodymium magnet (Nd—Fe—B) to form a platy powder having a thickness of 5 to 50 μm and pulverizing the platy powder to have a diameter of 50 to 250 μm.

9. The method of claim 1, wherein the binder is provided in an amount of 1 to 10 wt %.

10. The method of claim 1, further comprising mixing the mixture and the thermosetting resin, drying the resulting mixture in a vacuum oven at 60° C. or less for 30 min to 2 hours, providing a lubricant in an amount of 0.01 to 2% based on an amount of the powder, pressing the powder using a mold, and performing heat treatment to the pressed powder at 100° C. or more for 30 min to 2 hours.

11. The method of claim 1, further comprising processing the manufactured alloy powder using the HDDR process to form an anisotropic alloy powder.
